(19) United States
(12) Patent Application Publication
(10) Pub. No.: US 2006/0080876 A1
(43) Pub. Date: Apr. 20, 2006

(54) Collapsible yard sign

(76) Inventor: Michael Duane Carter, Orange Park, FL (US)

Correspondence Address: ROGERS TOWERS, P.A., 1301 RIVERPLACE BOULEVARD, SUITE 1500, JACKSONVILLE, FL, 32207, US

(21) Appl. No.: 11/253,878

(22) Filed: Oct. 19, 2005

Related U.S. Application Data
(60) Provisional application No. 60/620,515, filed on Oct. 20, 2004.

(51) Int. Cl. G09F 15/00

(52) U.S. Cl. 40/607.09

(57) ABSTRACT

A collapsible yard sign having a top arm sleeve and bottom arm removably connected to a post member, wherein after removal the post member is inserted into the top arm sleeve. A flexible sign is removably attached between the top arm sleeve and the bottom arm member, the sign and bottom arm member being stored within the post member in the disassembled state. The post member is provided with a ground anchor insertable into the ground.

This application claims the benefit of U.S. Provisional Patent Application Ser. No. 60/620,515, filed Oct. 20, 2004, the disclosure of which is incorporated herein by reference.

### BACKGROUND OF THE INVENTION

This invention relates generally to the field of relatively small, temporary, portable signs that are constructed to be inserted into the ground, and more particularly to such signs having components that can be collapsed or disassembled.

Small, temporary, portable signs of the type often referred to as yard signs are well known. These signs are constructed so as to be readily transportable and relatively easily inserted into and removed from the ground. Such signs are commonly used to advertise homes for sale or rent, or to provide information as to various events such as yard sales, community events, etc. One common sign structure comprises a generally rectangular metal frame, usually a few feet in height, with one or two legs that are inserted into the ground, with an information panel, a rectangular or tubular housing containing fliers, or similar means suspended between or attached to the frame members. Another common sign structure comprises a vertical wooden post, which may extend up to about six feet, and a horizontally extending wooden arm, likewise with an information panel, a rectangular or tubular housing containing fliers, or similar means connected to the horizontal arm. Problems with these signs include rusting, bending, difficulty of insertion and removal, and weight. In addition, the signs are bulky such that transportation and storage is difficult.

It is an object of this invention to address the above problems by providing a sign that is lightweight, durable, easy to insert and remove, and easy to transport and store, wherein the sign is able to be collapsed or disassembled into a non-use configuration with the sign itself forming a storage container for certain of the removable components. It is a further object to provide such a sign capable of displaying various information delivery members, such that the sign is versatile in application.

### SUMMARY OF THE INVENTION

The invention comprises a relatively small, transportable sign that can be collapsed or disassembled for transport and storage, the sign being easily inserted and removed from the ground, and wherein the disassembled components of the sign can be arranged in a non-use, storage configuration wherein some of the disassembled components are stored within other components.

The sign comprises an open-topped, vertical post member joined to a ground anchor that is easily inserted by pressing down on a footplate to drive anchoring spikes into the ground. A top arm sleeve member is mounted on the upper end of the post member to extend horizontally. An information display panel or sign member depends from the top arm sleeve member. The top arm sleeve member is joined to a removable post connector, the post connector having a first post-receiving aperture that receives the vertical post member whereby the top arm sleeve is disposed horizontally. A second post-receiving aperture is provided in the post connector opposite the top arm sleeve member, whereby the post connector and top arm sleeve member can be removed from the post member and positioned co-axially on the post member with the upper portion of the post member extending into the interior of the top arm sleeve member. Preferably, a bottom arm member is temporarily joined to the vertical post member in a horizontal position below the top arm sleeve member, such that the bottom of the sign member can be connected to the bottom arm member. The sign member is removable from the top arm sleeve member and the bottom arm member, whereby the sign member can be rolled or folded into a tight configuration such that the sign member and the bottom arm member can be inserted into the open top of the post member prior to insertion of the post member into the top arm sleeve member.

Additionally, rectangular chain signs may be provided for the display of additional information, each chain sign having an upper rail member and a lower slot member, whereby the rail members are received in slots disposed on the top arm sleeve member and the bottom arm member, and further whereby multiple chain signs can be joined together. Preferably, the sign member is provided with upper and lower rail members that are received in clots disposed in the top arm sleeve member and the bottom arm member. Furthermore, a printed-information receptacle may be provided, the receptacle mounting onto the top arm sleeve member.

The sign is preferably composed of a plastic material and the post member and top arm member are preferably formed with an oval or elliptical cross-section.

### BRIEF DESCRIPTION OF THE DRAWINGS

FIG. 1 is a perspective view of the invention in the assembled or in-use configuration.

FIG. 2 is an expanded view of the main components of the invention shown as disassembled, illustrating the coaxial storage orientation of the post member, the sign member, the bottom arm member and the top arm sleeve member.

FIG. 3 is a perspective view of the invention in the non-use or storage configuration.

FIG. 4 is a view of the sign member and the upper rail or clamping member.

FIG. 5 is a cross-sectional view of the upper rail member taken along line V-V of FIG. 4.

FIG. 6 is an end view of the top arm sleeve member, showing the upper and lower slot members.

FIG. 7 is an end view of the bottom arm member, showing the upper and lower slot members.

FIG. 8 is an end view of the chain sign, showing the upper rail member and the lower slot member.

### DETAILED DESCRIPTION OF THE INVENTION

With reference now to the drawings, the invention will now be described with regard for the best mode and the preferred embodiment. In a general sense, the invention is a sign to be temporarily inserted into the ground, the sign comprising elements that may be collapsed or disassembled so as to be able to be arranged in a compact non-use or storage configuration. Most preferably, the majority of components of the sign are composed of a plastic material, but other materials may be utilized.

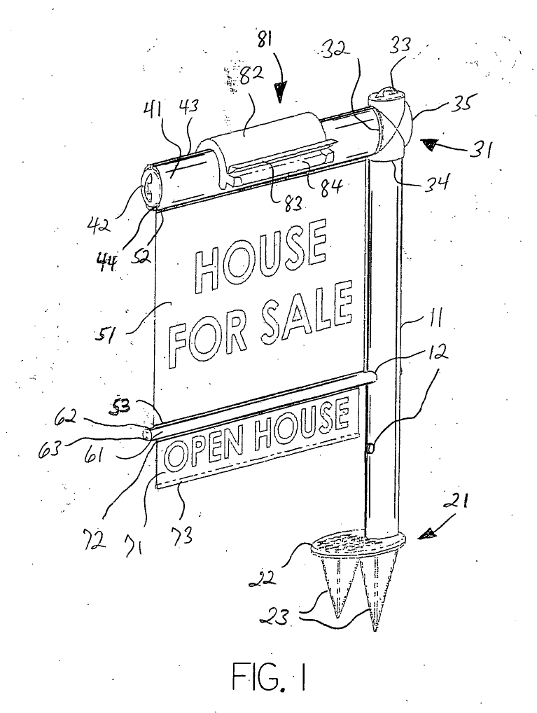

As illustrated in FIG. 1, the invention comprises a sign that is easily affixed or inserted in the ground, the sign comprising in general a vertically disposed post member 11 and a horizontally disposed top arm sleeve member 41. The sign is secured to the ground by a ground anchor 21 joined to the bottom of the post member 11, the ground anchor comprising a footplate 22 and one or more anchoring spike members 23. Insertion of the sign is accomplished by pressing down on the footplate 22 to drive the anchoring spike members 23 into the ground such that the post member 11 extends generally vertically, the anchoring spike members 23 being shown as generally triangular but with the understanding that other configurations will be suitable. The post member 11 is an elongated tubular member having an open top 13 providing access to an open or hollow interior area or storage recess 14. Preferably, the post member 11 is oval or elliptical in cross-section for strength and alignment purposes, but it is to be understood that the post member 11 may be circular, rectangular, triangular, etc. in cross-section. The post member 11 is preferably provided with one or more means to temporarily retain a horizontally disposed bottom arm member 61, which as shown comprise receiving apertures 12 into which bottom arm member 61 may be securely inserted.

The top arm sleeve member 41 is an elongated tubular member having a fixed end cap or closed end 42 that closes one end of the top arm sleeve member 41, the other end remaining open. To this open end is affixed a post connector 31, the post connector 31 being adapted to securely yet removably mount the top arm sleeve member 41 to the upper end of the post member 11 such that the top arm sleeve member 41 is generally horizontally disposed when the post member 11 is vertically disposed. The post connector 31 is a generally cross-shaped component and comprises a top arm receiving aperture or bore 32 that receives or is joined to the open end of the top arm sleeve member 41, such that the interior of the top arm sleeve member 41 is still accessible. The post connector 31 further comprises a fixed end cap or closed end 33, a first post-receiving aperture or bore 34 disposed opposite to the fixed end cap 33, and a second post-receiving aperture or bore 35 disposed opposite to the top arm receiving aperture 32 and the top arm sleeve member 41. The inner diameter of the top arm sleeve member 41, the top arm receiving aperture 32, the first post-receiving aperture 34 and the second post-receiving aperture 35 are greater than the outer diameter of the post member 11, such that the upper end of the post member 11 may be inserted into the post connector 31 through either the first post-receiving aperture 34 or the second post-receiving aperture 35. Preferably the cross-sectional configuration of the top arm sleeve member 41 corresponds to the cross-sectional configuration of the post member 11, with an oval or elliptical configuration being preferred.

With this structure, the in-use configuration of the invention is accomplished by mounting the top arm sleeve member 41 to the upper end of the post member 11 by inserting the post member 11 through the first post-receiving aperture 34 so as to abut the closed end at the fixed end cap 33, as shown in FIG. 1. The top arm sleeve member 41 extends generally perpendicularly to the post member 11. The invention further comprises an information display panel or sign member 51 that is removably connected to the top arm sleeve member 41. The sign member 51 is composed of a flexible material, such as vinyl, such that the sign member 51 can be removed from the top arm sleeve member 41 and rolled or folded into a generally cylindrical configuration, as shown in FIG. 2. Various indicia can be applied to the sign member 51 by screen printing or other known printing means.

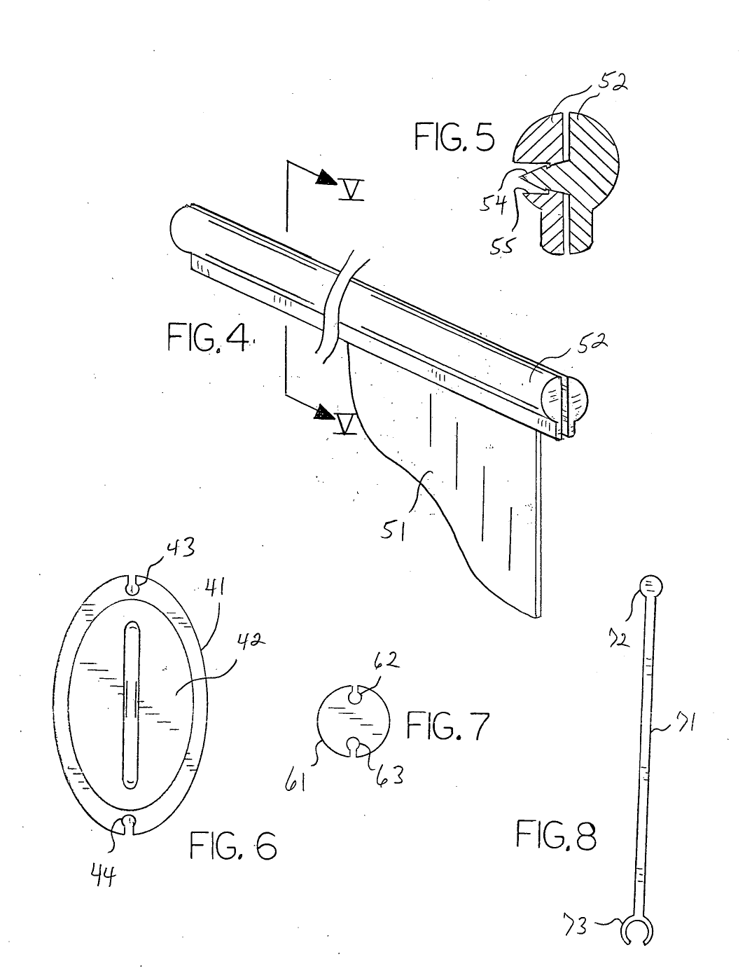

Preferably the sign member 51 is removably mounted to the top arm sleeve member 41 using sign retaining means, preferably comprising an upper rail or clamping member 52, as shown in FIGS. 4 and 5. The upper rail member 52 may be divided into two halves, or may be hinged, and is provided with piercing members 54 that pierce the material of the sign member 51 and are received in bores 55. In this manner the upper rail members 52 is removable so as to be useable with different sign members 51. The upper rail member 52 has a cross-sectional configuration, shown as generally circular in FIGS. 4 and 5, that is adapted to be received in an upper slot member 43 having a corresponding configuration and disposed on the underside of top arm sleeve member 41, as shown in FIG. 6. Alternatively, the upper retaining means may be permanently mounted to the sign member 51, or other equivalent mechanisms for attaching the sign member 51 to the top arm sleeve member 41 temporarily or permanently may be utilized.

Again preferably, the invention further comprises a bottom arm member 61 that is removably connected to the post member 11 such that it is generally horizontally disposed below the top arm sleeve member 41. As shown in the figures, the bottom arm member receiving means preferably comprises one or more apertures 12 disposed in the post member 11, whereby one end of the bottom arm member 61 may be inserted therein, the presence of multiple apertures 12 allowing for accommodation of sign member 51 of different heights. The bottom arm member 61 is provided with sign attachment means, preferably comprising an upper slot 62 disposed on the top of the bottom arm member 61, the upper slot 62 having a configuration, shown as circular in FIG. 7, corresponding to a lower rail or clamp member 53, which may be similar or identical in construction to upper rail member 52. In this manner the sign member 51 may be attached to both the top arm sleeve member 41 and the bottom arm member 61 for added security.

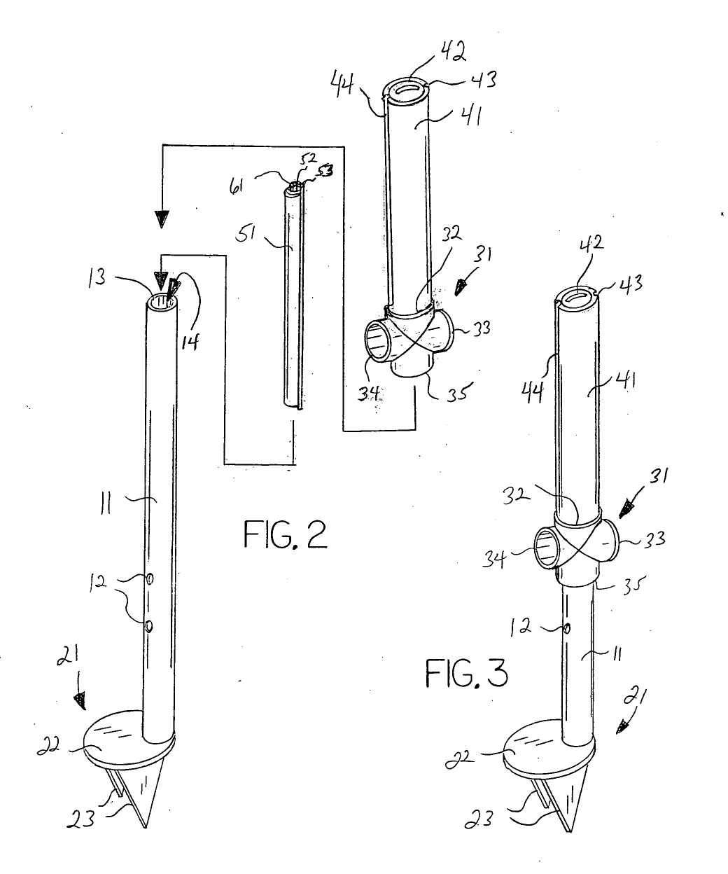

The invention is collapsed or disassembled by removing the sign member 51 from the top arm sleeve member 41 and the bottom arm member 61. The post connector 31 and top arm sleeve member 41, and the bottom arm member 61, are then removed from the end of the post member 11. The sign member 51, upper rail member 52 and lower rail member 53 are then folded or rolled into a cylindrical configuration, as seen in FIG. 2. The bottom arm member 61 and the rolled sign member 51 assembly is then inserted through the open top 13 into the open interior 14 of the post member 11, which is now exposed due to the removal of the post connector 31, so as to be stored and protected within the post member 11. The top arm sleeve member 41 and the post connector 31 is then coaxially aligned with and slipped over the post member 11, the upper open end 13 of the post member 11 passing through the second post-receiving aperture 35 until the closed end of the top arm sleeve member 41 is abutted. In this non-use or storage configuration, shown in FIG. 3, the sign member 51, rail members 52 and 53, and the bottom arm member 61 are retained within the post member 11, and the top arm sleeve member 41 closes and encases the post member 11 in telescoping manner. In this arrangement, the sign comprises a linear configuration and is easily transported and stored.

The invention may further comprise chain sign members 71, often referred to in the industry as riders, the chain sign members 71 being composed of a relatively rigid material and comprising an upper rail member 72 and a lower slot member 73, as shown in FIG. 8. The top arm sleeve member 41 is provided with an upper slot member 43 corresponding in configuration to the upper rail member 72 of the chain sign member 71, and/or the bottom arm member 61 is provided with a lower slot member 63 corresponding in configuration to the upper rail member 72 of the chain sign member 71, such that the chain sign member 71 may be temporarily mounted to either by insertion of the upper rail member 72 into the appropriate slot member 43 or 53. In addition, multiple chain sign members 71 may be joined to each other by inserting the upper rail member 72 of one chain sign member 71 into the lower slot member 73 of another chain sign member 71. The chain sign member 71 is imprinted with indicia as desired.

A printed-information receptacle 81, often referred to in the industry as a “take one” box, may be provided. In a preferred embodiment, the receptacle 81 comprises a curved body 82 that snugly fits about the top arm sleeve member 41, as shown in FIG. 1. The receptacle 81 is provided with a hinged cover or lid 83 that exposes an opening 84 such that brochures, fliers or the like may be removed from the receptacle 81. In the storage configuration, the receptacle 81 may remain affixed to the top arm sleeve member 41 without excessively detracting from the linear configuration. Furthermore, the fixed end caps 33 and 42 may be provided with handles or other means for attachment of balloons and the like.

It is understood that equivalents and substitutions for certain elements or components set forth above may be obvious to those skilled in the art, and therefore the true scope and definition of the invention is to be as set forth in the following claims.

I claim:

1. A collapsible sign comprising:
a post member having an open top and an open interior;
a top arm sleeve member joined to a post connector, said post connector being removably mounted on said post member;
a sign member removably attached to said top arm sleeve member;
whereby in an in-use configuration said post connector is mounted on said post member such that said top arm sleeve extends generally perpendicularly to said post member; and
whereby in a non-use configuration said post member and said sign member are disconnected from said top arm sleeve member, said sign member is inserted into said post member and said post member is co-axially inserted into said post connector and said top arm sleeve member.

2. The sign of claim 1, wherein said post connector comprises a closed end cap, a first post-receiving aperture and a second post receiving aperture;
whereby in said in-use configuration said post member extends through said first post-receiving aperture; and
whereby in said non-use configuration said post member extends through said second post-receiving aperture.

3. The sign of claim 1, wherein said post connector is generally cross-shaped.

4. The sign of claim 1, further comprising a bottom arm member removably connected to said post member and said sign member;
whereby in said non-use configuration said bottom arm member is disconnected from said post member and said sign member and is co-axially inserted into said post member.

5. The sign of claim 2, further comprising a bottom arm member removably connected to said post member and said sign member;
whereby in said non-use configuration said bottom arm member is disconnected from said post member and said sign member and is co-axially inserted into said post member.

6. The sign of claim 1, further comprising a ground anchor connected to said post member.

7. The sign of claim 1, further comprising sign retaining means comprising an upper rail member connected to said sign member, wherein said top arm sleeve member further comprises a lower slot member, whereby said sign member upper rail member is removably received by said top arm sleeve member lower slot member.

8. The sign of claim 2, further comprising sign retaining means comprising an upper rail member connected to said sign member, wherein said top arm sleeve member further comprises a lower slot member, whereby said sign member upper rail member is removably received by said top arm sleeve member lower slot member.

9. The sign of claim 4, further comprising sign retaining means comprising an upper rail member connected to said sign member, wherein said top arm sleeve member further comprises a lower slot member, whereby said sign member upper rail member is removably received by said top arm sleeve member lower slot member; and further comprising a lower rail member connected to said sign member, wherein said bottom arm member further comprises an upper slot member, whereby said sign member lower rail member is removably received by said bottom arm member upper slot member.

10. The sign of claim 5, further comprising sign retaining means comprising an upper rail member connected to said sign member, wherein said top arm sleeve member further comprises a lower slot member, whereby said sign member upper rail member is removably received by said top arm sleeve member lower slot member; and further comprising a lower rail member connected to said sign member, wherein said bottom arm member further comprises an upper slot member, whereby said sign member lower rail member is removably received by said bottom arm member upper slot member.

11. The sign of claim 1, further comprising a printed information receptacle mounted on said top arm sleeve member.

12. The sign of claim 1, wherein said bottom arm member further comprises a lower slot member, and further comprising a chain sign member having an upper rail member, whereby said chain sign member upper rail member is removably received by said bottom arm member lower slot member.

13. The sign of claim 12, wherein said chain sign member further comprises a lower slot member.

14. The sign of claim 1, wherein said top arm sleeve member further comprises an upper slot member, and further comprising a chain sign member having an upper rail member, whereby said chain sign member upper rail member is removably received by said top arm sleeve member upper slot member.

15. The sign of claim 1, wherein said post member and said top arm sleeve member are elliptical in cross-section.

16. A collapsible sign comprising:
a post member having an open top and an open interior;
a ground anchor connected to said post member;
a top arm sleeve member joined to a post connector, said post connector being removably mounted on said post member, said post connector being generally cross-shaped and comprising a closed end cap, a first post-receiving aperture and a second post receiving aperture;
a bottom arm member removably connected to said post member and said sign member;
a sign member removably attached to said top arm sleeve member and said bottom arm member;
whereby in an in-use configuration said post connector is mounted on said post member such that said post member extends through said first post-receiving aperture and said top arm sleeve extends generally perpendicularly to said post member; and
whereby in a non-use configuration said post member is disconnected from said top arm sleeve member, said sign member is disconnected from said top arm sleeve member and from said bottom arm member, said bottom arm member is disconnected from said post member, said sign member and said bottom arm member are inserted into said post member and said post member is co-axially inserted into said post connector through said second post-receiving aperture and into said top arm sleeve member.

17. The sign of claim 16, further comprising sign retaining means comprising an upper rail member connected to said sign member, wherein said top arm sleeve member further comprises a lower slot member, whereby said sign member upper rail member is removably received by said top arm sleeve member lower slot member; and further comprising a lower rail member connected to said sign member, wherein said bottom arm member further comprises an upper slot member, whereby said sign member lower rail member is removably received by said bottom arm member upper slot member.

18. The sign of claim 17, wherein said bottom arm member further comprises a lower slot member, and further comprising a chain sign member having an upper rail member, whereby said chain sign member upper rail member is removably received by said bottom arm member lower slot member.

19. The sign of claim 18, wherein said top arm sleeve member further comprises an upper slot member, and further comprising a chain sign member having an upper rail member, whereby said chain sign member upper rail member is removably received by said top arm sleeve member upper slot member.

20. The sign of claim 19, wherein said chain sign member further comprises a lower slot member.
